(19) United States
(12) Patent Application Publication
(10) Pub. No.: US 2007/0228104 A1
(43) Pub. Date: Oct. 4, 2007

(54) Friction stir welding spindle assembly

(76) Inventors: Gary R. Mankus, Bristol, CT (US); Yefim Gorelik, Hamden, CT (US); Joseph A. Berlyand, North Andover, MA (US)

Correspondence Address: DICKSTEIN SHAPIRO LLP, 1177 AVENUE OF THE AMERICAS (6TH AVENUE), NEW YORK, NY, 10036-2714, US

(21) Appl. No.: 11/395,723

(22) Filed: Mar. 31, 2006

(51) Int. Cl. A47J 36/02

(52) U.S. Cl. 228/101

(57) ABSTRACT

A friction stir welding system is provided that can afford a versatile and efficient welding operation. The friction stir welding spindle assembly can have a shoulder spindle and a pin spindle independently rotatable in relation to each other. The shoulder spindle and the pin spindle can be rotatably supported by a shoulder housing and a pin housing, respectively. The pin housing can be rotatably supported in the shoulder housing and adapted to be axially movable in relation to the same between a forward position and a retracted position. Additionally or alternative, the shoulder spindle and the pin spindle can each be provided with an adapter, which has a predetermined mounting surface for mounting a tool thereon.

### FIELD OF THE INVENTION

The present invention relates generally to a friction stir welding system. In particular, the present invention relates to a spindle assembly for use in a friction stir welding apparatus. More specifically, the present invention relates to a spindle assembly having coaxial shoulder and pin spindles capable of rotating independently of each other.

### BACKGROUND OF THE INVENTION

Friction stir welding (FSW) has been used to join two workpieces in a solid state. For example, friction stir welding can be used to weld a butt joint formed between adjacent metal pieces, such as aluminum alloys, copper alloys, etc.

The FSW process uses a non-consumable rotating tool comprised of a shoulder and a pin extending from the shoulder. To effect a weld, the tool is rotated and the pin is forced into the joint of the adjacent workpieces until a surface of the shoulder contacts the upper surfaces of the workpieces. The friction between the rotating tool and the metal workpieces plasticizes an annular region of the metal around the pin spindle. The rotating tool is then moved along the joint of the workpieces. As the pin is moved along the joint, the pressure provided by the leading face of the pin forces hot, plasticized metal to the back of the pin where the plasticized metal fills the void left by the moving pin. After cooling and hardening, the weld left is a fine grained, hot worked joint.

It is advantageous to provide a FSW tool that can be easily adjusted to weld various types of workpieces. For example, the FSW tool can be formed so that it can be easily assembled for FSW operation and/or dissembled for maintenance and repair.

In addition, in a FSW process, a substantial amount of heat is produced in the workpieces as well as in the rotating tool and adjacent machine components. The heat may be significant enough to adversely affect the performance or life of components adjacent the rotating tool, for example, the spindle bearings. Therefore, it is advantageous to provide a FSW machine that controls the temperature to thereby limit the heat transfer from the rotating tool and the welding area to other components of the FSW machine.

The present invention provides a friction stir welding spindle assembly that overcomes the above problems. More specifically, the present invention provides a friction stir welding spindle assembly capable of being easily adjusted to provide controllability and versatility. The present invention also provides a FSW apparatus that comprises a FSW spindle assembly and a control device for controlling a FSW processing.

### SUMMARY OF THE INVENTION

A friction stir welding system is provided that can afford a versatile and efficient welding operation. According to one aspect of the present invention, a friction stir welding spindle assembly can be provided which can comprise two coaxial spindles independently rotatable relative to each other. For example, the FSW spindle assembly can comprise a shoulder spindle and a pin spindle rotatably supported by a shoulder housing and a pin housing, respectively. The pin housing can be rotatably supported in the shoulder housing and adapted to be axially movable in relation to the same. The nose ends of the shoulder and pin spindles can be adapted to mount a shoulder tool and a pin head, respectively.

According to another aspect of the present invention, a FSW spindle assembly can be provided, in which two coaxial spindles can be supported to independently rotate relatively to each other. The FSW spindle assembly can comprise an adapter for mounting a tool onto a corresponding spindle. For example, a shoulder adapter can be provided to be fixed onto a nose end of a shoulder spindle and formed with a predetermined mounting surface, on which a shoulder tool can be mounted. Additionally or alternatively, the FSW spindle assembly can comprise a pin adapter for fixedly mounting a pin head onto a pin spindle.

According to a further aspect of the present invention, the FSW apparatus can comprises a FSW spindle assembly as discussed above and a control device for controlling a FSW process based on one or more welding parameters detected during a welding processing. For example, the FSW apparatus can comprise a rotating speed control unit for determining the rotating speed of each of the shoulder and pin spindles, a pin position control unit for determining a penetration position of the pin head relative the shoulder spindle, and/or a feeding speed control unit for determining a feeding speed of the spindle assembly. Additionally or alternatively, the welding apparatus can comprise a cooling system for adjusting an temperature of the spindle assembly during a welding process.

The welding parameters can comprise one or more of the following: a rotation speed of each of the shoulder and pin spindles, one or more of radial and axial forces and torque exerted on the shoulder and pin adapters during a friction stir welding process, a temperature detected at one or more of the shoulder adapter, the pin adapter, and a plurality of bearings used to rotatably support the shoulder and pin spindles, a pin position relative to the shoulder spindle in an axial direction, and a feeding speed of the spindle assembly.

### BRIEF DESCRIPTION OF THE DRAWINGS

The detailed description of the present invention will be better understood in conjunction with the accompanying drawings, in which:

FIG. 1 is a schematic representation of the friction stir welding system formed according to an exemplary embodiment of the present invention;

FIG. 2 is an axial cross-sectional view of the friction stir welding spindle assembly shown in FIG. 1;

FIG. 3 is an axial cross-sectional view of a shoulder adapter formed according to an exemplary embodiment of the present invention;

FIG. 4 is an axial cross-sectional view of a pin adapter formed according to an exemplary embodiment of the present invention; and

FIG. 5 is a block diagram of the control system formed according to an exemplary embodiment of the present invention.

### DETAILED DESCRIPTION OF THE INVENTION

Exemplary friction stir welding (FSW) systems, friction stir welding spindle assemblies, shoulder and pin adapters, as well as their various components are illustrated throughout the drawings. In the following description of various exemplary embodiments of the friction stir welding (FSW) systems, FSW spindle assemblies, and shoulder and pin adapters, similar elements or components thereof are designated with same reference numbers or characters and redundant description is omitted. It should be understood that the exemplary FSW systems, FSW spindle assemblies, shoulder and pin adapters, as well as their various components shown in the drawings are not to be considered limiting in any manner and that various features from the different embodiments are to be considered.

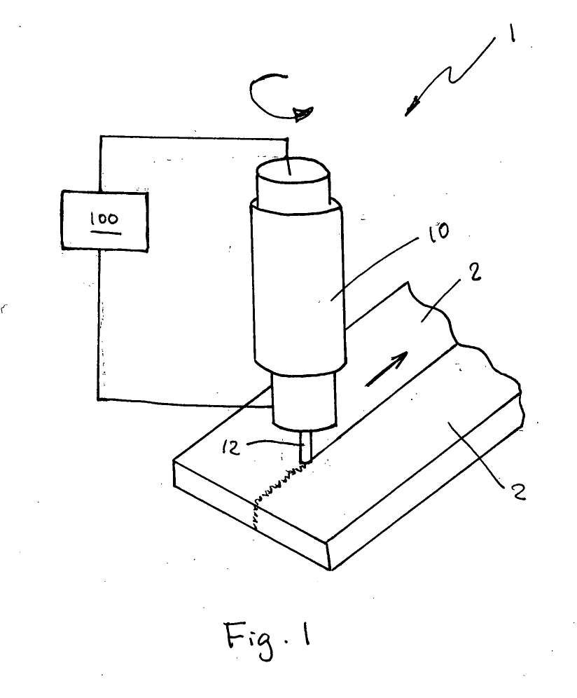

FIG. 1 shows a friction stir welding system 1 that is formed according to various exemplary embodiments of the present invention and is capable of affording versatile and efficient welding operation. The FSW system 1 can comprise a friction stir welding spindle assembly 10, which can be supported in various manners for transverse movement, such as along a joint line formed by workpieces 2. The FSW assembly 10 comprises a welding tool 12, which is adapted to engage the workpieces 2 and join the same through a friction stir welding process. The FSW system 1 can also comprise a control device 100 to monitor and control the operation of the FSW spindle assembly 10 and the friction stir welding process. The FSW spindle assembly 10 and the control device 100 will be described below.

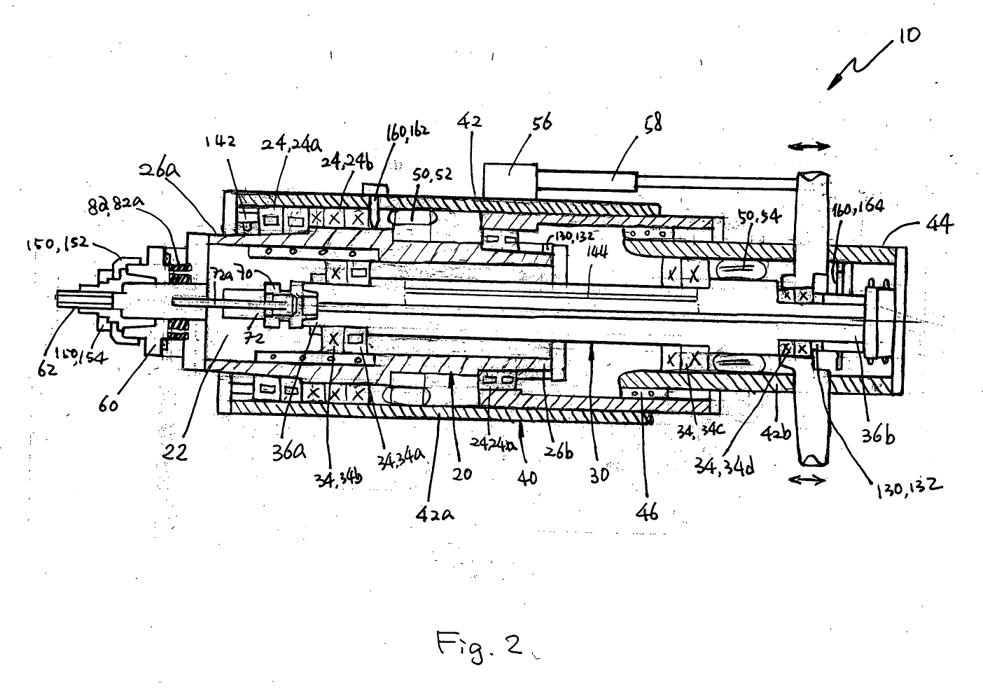

As shown in FIG. 2, the FSW spindle assembly 10 can comprise a shoulder spindle 20 and a pin spindle 30 rotatably supported by a spindle housing support 40 in various ways. In an exemplary embodiment, the shoulder spindle 20 and the pin spindle 30 are coaxially positioned in relation to each other. For example, the shoulder spindle 20 defines a chamber 22, through which at least a portion of the pin spindle 30 extends. It is desired that the housing support 40 is formed to sealingly enclose the shoulder and pin spindles 20 and 30, and various supporting components, driving components, and/or other operational components. One skilled in the art will appreciate that various methods and components can be used to enclose the shoulder and pin spindles 20 and 30 inside the spindle housing support 40, which are also within the scope of the present invention.

The shoulder spindle 20 can be rotatably supported but axially fixed by various methods. For example, the shoulder spindle 20 can be supported by one or more bearings 24 near its nose and rear ends 26a and 26b. In one exemplary embodiment, one or more cylindrical roller bearing 24a are used to support the shoulder spindle 20 inside the spindle housing support 40 and support a radial loading. The cylindrical roller bearing 24a can be provided at both the nose and rear ends 26a and 26b of the shoulder spindle 30. In another exemplary embodiment, a plurality of pairs of high contact angle ball bearings 24b can be provided to support the thrust loading. One skilled in the art will appreciate that various kinds of bearing 24 or other rotary support can be used to rotatably support the shoulder spindle 20 in the spindle housing support 40, which are also within the scope of the present invention.

The pin spindle 30 can be supported in various ways for both rotational and axial movements. For example, the pin spindle 30 can be supported by one or more bearings 34. In an exemplary embodiment, one or more cylindrical roller bearings 34a can be provided to rotatably support the pin spindle 30 near its nose end 36a. In another exemplary embodiment, one or more radial ball bearings 34b can be mounted in the spindle housing support 40 near the nose end 36a to support the thrust loading on the pin spindle 30. In another exemplary embodiment, a plurality sets of high contact angle, cronidur race, ceramic ball, ball bearings 34c can be provided near the read end 36b of the pin spindle 30 to support the thrust loading on the pin spindle 30. Additionally or alternatively, a duplex pairs of angular contact ball bearings 34d can be used to provide additional radial support for the pin spindle 30 at its nose end 36a. One skilled in the art will appreciate that various other kinds of bearings 34 or other rotary support can be used to rotatably support the pin spindle 30 in the shoulder housing support 40, which are also within the scope of the present invention.

The spindle housing support 40 can be formed in various ways to support the shoulder spindle 20 and the pin spindle 30. In one embodiment, the spindle housing support 40 can comprise a shoulder housing 42 and a pin housing 44 formed to rotatably support the shoulder spindle 20 and the pin spindle 30, respectively. In an exemplary embodiment, the shoulder spindle 20 and the pin spindle 30 can be axially fixed to the shoulder housing 42 and the pin housing 44, respectively, by various conventional methods. In another exemplary embodiment, the pin housing 44 can be mounted to be axially movable in relation to the shoulder housing 42, such as between a forward position and a retracted position. For example, the pin housing 44 can be supported inside at least a portion of the shoulder housing 42 by various bearings, such as linear ball bearings 46. In another exemplary embodiment, the pin housing 44 is fixed to the shoulder housing 42 in a rotational direction by various conventional methods.

In a desired embodiment, the shoulder housing 42 can be formed by two coaxial sub-housings 42a and 42b with the inner sub-housing 42b fitting inside the outer sub-housing 42a from its rear end 48. The sub-housings 42a and 42b can be so formed that the inner sub-housing 42b can be removably mounted inside the outer sub-housing 42a by various conventional means, such as screws. The two sub-housing structure can facilitate the assembling the FSW spindle assembly 10. One skilled in the art will appreciate that the shoulder and pin housings 42, 44 and the sub-housings 42a, 42b can be formed in various other manners, which are also within the scope of the present invention.

The FSW spindle assembly 10 provide the shoulder spindle 20 and the pin spindle 30 with versatility during a FSW operation. In one embodiment, the shoulder spindle 20 and the pin spindle 30 can be supported so that each of them can rotate in the opposite directions along their respective axes and/or rotate at different speeds. Additionally or alternatively, the shoulder spindle 20 and the pin spindle 30 can rotate independently from each other. For example, the shoulder spindle 20 and the pin spindle 30 can rotate in opposite directions and/or different speeds. The rotation direction and/or speed of each of the shoulder and pin spindles 20, 30 can be determined based on various factors, such as the materials and sizes of the workpieces 2 and/or the welding tool 12.

In another exemplary embodiment, the pin spindle 30 can be movable in the axial direction. For example, the pin spindle 30 can move axially between a forward position and a retracted position. In an exemplary embodiment, the pin spindle 30 can move axially for up to 170 mm. Various limit switches (not shown) can be used to define the axial limits and define the travel distance of the pin spindle 30.

The shoulder spindle 20 and the pin spindle 30 can be independently driven by various methods. For example, the spindles 20, 30 can be driven by independently controlled motors 50, such as AC induction motors 52, 54, respectively. The independently controlled motors 52, 54 can allow for the operation of each spindle 20 or 30 at a different operating speed and/or different rotating directions. For example, the maximum speed of the shoulder spindle 20 can be about 2000 RPM in either direction. The maximum speed of the pin spindle 30 can be about 6000 RPM when rotating in an opposite direction as the shoulder spindle 20. The maximum speed of the pin spindle 30 can be about 8000 RPM when rotating in the same direction as the shoulder spindle 20. One skilled in the art will appreciate that the various rotating speeds of the spindles 20, 30 can be designed according to various working conditions, which are also within the scope of the present invention.

The pin spindle 30 can be driven axially by various means. In one exemplary embodiment, the pin spindle 30 can be axially driven by one or more motors 56, such as servo motors. For example, one or more ball screws 58 can be provided to join the pin housing 44 to the motors 56. The motors 56 can drive the ball screws 58, which drives the pin housing 44 and, in turn, the pin spindle 30 in the axial direction. One skilled in the art will appreciate that the pin spindle 30 can be moved in the axial direction by various other means, which are also within the scope of the present invention.

Additionally or alternatively, the spindle assembly 10 so formed can support various axial and radial loads. For example, the shoulder spindle 20 is capable of supporting up to about 4000 pound radial load and about 8000 pound axial load. The pin spindle 30 is capable of supporting up to about 2000 pound radial load and about 4000 pound axial load.

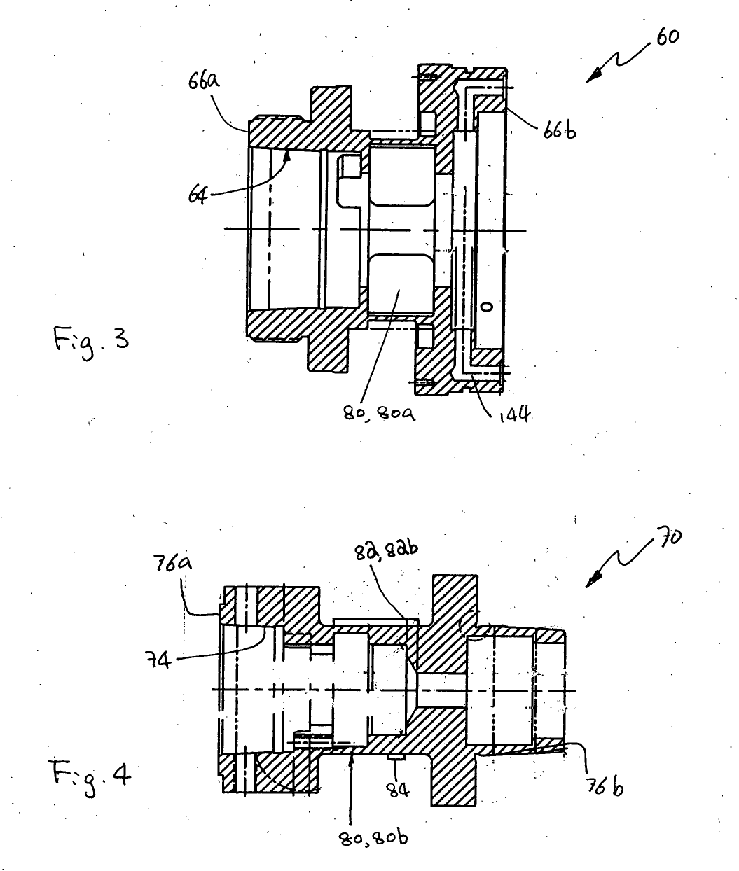

According to another embodiment, the FSW spindle assembly 10 can comprise tool adapters for mounting tools onto the shoulder and pin spindles 20 and 30. In one exemplary embodiment, a shoulder adapter 60 can be provided for mounting a shoulder tool 62 onto the shoulder spindle 20. As illustrated in FIG. 3, the shoulder adapter 60 can be formed to have a sleeve shape defining a socket 64 at one end 66a for connecting to a shoulder tool 62. The shoulder adapter 60 can have its other end 66b adapted to be attached to the nose end 26a of the shoulder spindle 20 in various conventional manners. In a desired embodiment, the shoulder adapter 60 can be a modified HSK-100A tool, whereby the standard HSK-100A socket 64 provides a ready connection to a commercially available shoulder tool 62. One skilled in the art will appreciate that the shoulder adapter 60 can be formed by various other ways, which are also within the scope of the present invention.

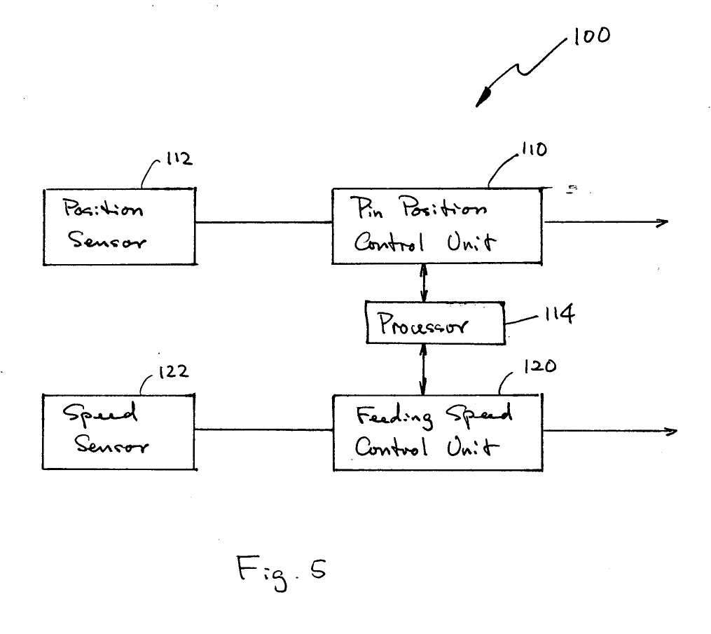

In another exemplary embodiment, the FSW spindle assembly 10 can comprise a pin adapter 70 for mounting a pin head 72 onto the pin spindle 30. As illustrated in FIG. 4, the pin adapter 70 can be formed to have a sleeve shape defining a socket 74 at one end 76a for receiving a pin head 72. In a desired embodiment, the pin adapter 70 can be a modified HSK-40A tool, whereby the standard HSK-40A socket 74 provides a ready connection to a commercially available pin head 72. The pin adapter 70 can have its other end 76b adapted to be attached to the nose end 36a of the pin spindle 30. For example, the other end 76b of the pin adapter 70 can have a circumferential surface 78 formed to be joined to the nose end 36a of the pin spindle 30. One skilled in the art will appreciate that the pin adapter 70 can be formed by various other ways, which are also within the scope of the present invention.

In an exemplary embodiment, the pin head 72 can be formed to have a pin tool 72a extendible between a retracted position and an operation position where the pin tool 72a engages the workpieces 2. The pin tool 72a can be driven by various methods, such as by a hydraulic system. One skilled in the art will appreciate that the pin tool 72a can be formed by various other ways, which are also within the scope of the present invention.

The shoulder adapter 60 and the pin adapter 70 can each be formed with one or more sensors detect various operating and working conditions during a FSW process. In one exemplary embodiment, the shoulder adapter 60 and the pin adapter 70 can each be formed with a weakened section 80, such as to provide additional safety measure to the FSW system 1. For example, the weakened section 80 can be formed between the two shoulder adapter ends 66a and 66b and/or between the two pin adapter ends 76a and 76b. In an exemplary embodiment as shown in FIG. 3, the weakened section 80a can comprise a partially discontinued body portion on the shoulder adapter 60. In another exemplary embodiment as shown in FIG. 4, the weakened section 80b can be in the form of a thinned body portion on the pin adapter 70. One skilled in the art will appreciate that the weakened section 80 can be formed by various other ways, which are also within the scope of the present invention.

In another exemplary embodiment, the shoulder adapter 60 and the pin adapter 70 can each be formed with one or more strain sensors 82 for detecting axial and radial forces and/or torque. Various sensors 82 can be used for this purpose. For example, the strain sensors 82 can be strain gauges or strain gauge bridges. In an exemplary embodiment, one or more strain gauges 82a can be formed on at least one of the shoulder and pin adapters 60 and 70 for detecting axial or radial forces exerted thereon. In another exemplary embodiment, one or more strain gauge bridges 82b can be used on one or both of the shoulder and pin adapters 60 and 70 to output axial and/or radial forces and/or torque. One skilled in the art will appreciate that the strain sensors 82 can be in various other forms, which are also within the scope of the present invention.

The strain sensors 82 can be formed on the shoulder and pin adapters 60 and 70 in various ways. In an exemplary embodiment, the strain gauges 82a or 82b can be formed over a circumferential surface of the shoulder and pin adapters 60 and 70. In a desired embodiment, the strain gauges 82a or 82b can be formed over at least a portion of the weakened sections 80a and 80b on the shoulder and pin adapters 60 and 70, respectively. Various conventional methods can be used to affix the strain gauges 82a or 82b on the shoulder and pin adapters 60 and 70. For example, adhesive materials can be used. One skilled in the art will appreciate that the strain sensors 82 can be affixed onto the shoulder and pin adapters 60 and 70 by various other methods, which are also within the scope of the present invention.

In a further exemplary embodiment, the shoulder adapter 60 and the pin adapter 70 can each be formed with one or more temperature sensors 84 to measure the temperature of such adapters 60 and 70. For example, temperature sensors 84 can be provided on the shoulder and pin adapters 60 and 70 in a nearby region where the strain sensors 80 are provided, such as shown in FIG. 4. Temperature sensors 84 can be affixed onto the adapters 60 and 70 by various methods, such as adhesion. In an exemplary embodiment, temperature sensors 84 are thermocouples. One skilled in the art will appreciate that temperature sensors 84 can be in various other forms and affixed onto the shoulder and pin adapters 60 and 70 by various other methods, which are also within the scope of the present invention.

The output signals by the various strain sensors 82 and/or temperature sensors 84 can be transmitted to the control device 100 by various methods for use to monitor and control a FSW process. For example, a rotary slip ring assembly (not shown) can be used for each of the shoulder and pin spindles 20 and 30. The control device 100 thus can be placed in stationary location. One skilled in the art will appreciate that various other methods can be used to transmit the output signals, which are also within the scope of the present invention.

The FSW control device 100 is now described. As shown in FIG. 5, the control device 100 can comprise various sections for controlling a FSW process. The control device 100 can control a FSW process based on one or more welding parameters detected during a FSW processing including, but not limited to, a rotation speed of each of the shoulder and pin spindles, one or more of radial and axial forces and torque exerted on the shoulder and pin adapters during a friction stir welding process, a temperature detected at one or more of the shoulder adapter, the pin adapter, and a plurality of bearings used to rotatably support the shoulder and pin spindles, a pin position relative to the shoulder spindle in an axial direction, an angular position of at least one of the shoulder and pin spindles, and a feeding speed of the spindle assembly. One skilled in the art will appreciate that various other welding parameters can be used to control a FSW process, which are also within the scope of the invention.

In one exemplary embodiment, the control device 100 can comprise a pin position control unit 110 for determining and controlling a penetration position of the pin head 72 relative the shoulder spindle 20. In an exemplary embodiment, one or more position sensor 112 can be employed for this purpose. The output signals of the position sensors 112 can be fed back to the driving system driving the welding pin tool 72a in the pin head 72. For example, the measured position value can be compared with a predetermined value to determine if and how the pin position is to be adjusted. Various conventional processors 114 can be employed to carry out the comparison. One skilled in the art will appreciate that various other methods can be used to determine and adjust the penetration position of the pin head 72, which are also within the scope of the present invention.

In another exemplary embodiment, the control device 100 can comprise a feeding speed control unit 120 for determining and controlling a feeding speed of the spindle assembly 10. Various conventional speed sensors 122 can be adopted for this purpose. The output signals of the speed sensors 122 can be fed back to a feeding system of the FSW spindle assembly 10. For example, the measured speed value can be compared with a predetermined value, such as by a processor 114, to determine if and how the feeding speed is to be adjusted. One skilled in the art will appreciate that various other methods can be used to determine and adjust the feeding speed of the spindle assembly 10, which are also within the scope of the present invention.

In a further exemplary embodiment, the control device 100 can comprise one or more encoders 130 for determining and controlling the position of at least one of the shoulder and pin spindles 20 and 30. Various types of encoders 130 can be used for these purposes. In an exemplary embodiment, one or more rotary encoders 132 can be provided to determine and control an angular position of at least one of the shoulder and pin spindles 20 and 30. The output of the rotary encoders 132 can be fed back to the controls for the motors 52 and 54 to control and adjust the rotation speed and/or direction of each of the motors 52 and 54. Additionally or alternatively, the output of the rotary encoder 132 in conjunction with other devices can be used to determine other operational conditions, such as a reaction force of the welds generated by the welding tool 12.

In another exemplary embodiment, an absolute linear encoder (not shown) can be used to be connected to the pin spindle 30 and the shoulder housing 42 for determine the relative linear position of the pin spindle 30 to the shoulder spindle 20. One skilled in the art will appreciate that various other methods or encoders 130 can be used to determine and adjust angular position of at least one of the shoulder and pin spindles 20 and 30, which are also within the scope of the present invention.

According to a further embodiment, the FSW system 1 can comprise a cooling system 140 for measuring and/or adjusting an temperature of the FSW spindle assembly 10 during a FSW process. For example, one or more additional temperature sensors 142 (FIG. 2) can be provided to measure the temperature of one or more of the various bearings 24 and 34. In one exemplary embodiment, the cooling system 140 can comprise a coolant conduit 144 (FIGS. 2 and 3) formed in one or more of the shoulder spindle 20, the pin spindle 30, the spindle housing support 40, motors 52 and 54, the shoulder adapter 60, and the pin adapter 70. For example, the coolant conduit 144 can be one or more long gun drilled holes.

Various coolants can be used, which can be introduced into the coolant conduit 144 by various conventional methods, such as through a coolant transfer gland (not shown). In an exemplary embodiment, the coolant transfer gland can employ Teflon seals and/or chromium oxide wear surface coating. In a desired embodiment, a pair of seals are provided and arranged in a redundant configuration. In an exemplary embodiment, a leakage detector (not shown) can be formed, such as by providing a vacuum between the seals. One skilled in the art will appreciate that the cooling system 140 and its components can be formed by various other methods, which are also within the scope of the present invention.

The FSW system 1 can be provided with various accessory devices to facilitate adjusting and assembling the FSW spindle assembly 10. In one exemplary embodiment, the shoulder adapter 60 can be provided with a mounting tool 150 for mounting the shoulder tool 62 onto the shoulder spindle 20. For example, the mounting tool 150 can be in the form of a splined nut 152 and an ejection ring 154, such as shown in FIG. 2. The splined nut 152 can be sandwiched between the ejection ring 154 and a mounting flange of the shoulder adapter 60. The splined nut 152, when being rotated, such as clockwise direction, can draw the shoulder tool 62 onto the shoulder adapter 60. When the splined nut 152 is being rotated in the opposite direction, such as counter-clockwise direction, the splined nut 152 can bias against the ejection ring 154 and push the shoulder tool 62 away from the shoulder adapter 60. In another exemplary embodiment, an assembly tool (not shown) can be provided to assist in tightening or loosening the splined nut 152. One skilled in the art will appreciate that the mounting tool 150 and its components can be formed in various other ways, which are also within the scope of the present invention.

In a further embodiment, one or more clamping device 160 can be provided to maintain one or both of the shoulder and pin spindles 20 and 30 in place, such as during maintenance. For example, after the shoulder and pin spindles 20 and 30 are turned to a predetermined position, such as by using one or more of the encoders 130, the clamping device 160 can be used to maintain the spindles 20 and 30 in such a predetermined position. In one exemplary embodiment, the pin spindle 30 can be maintained at a plurality of positions. The clamping device can be formed in various ways. For example, the clamping device can mechanically clamp the spindles 20 and 30 to the spindle housing support 40. In one exemplary embodiment, the clamping device can be a shot pin 162, a disc brake 164, and the like. In another exemplary embodiment, the clamping device 160 can be pneumatically actuated. One skilled in the art will appreciate that the clamping device and its components can be formed in various other ways, which are also within the scope of the present invention.

It will be appreciated that the various features described herein may be used singly or in any combination thereof. Therefore, the present invention is not limited to only the embodiments specifically described herein. While the foregoing description and drawings represent a preferred embodiment of the present invention, it will be understood that various additions, modifications, and substitutions may be made therein without departing from the spirit and scope of the present invention as defined in the accompanying claims. In particular, it will be clear to those skilled in the art that the present invention may be embodied in other specific forms, structures, arrangements, proportions, and with other elements, materials, and components, without departing from the spirit or essential characteristics thereof. One skilled in the art will appreciate that the invention may be used with many modifications of structure, arrangement, proportions, materials, and components and otherwise, used in the practice of the invention, which are particularly adapted to specific environments and operative requirements without departing from the principles of the present invention. The presently disclosed embodiment is therefore to be considered in all respects as illustrative and not restrictive, the scope of the invention being indicated by the appended claims, and not limited to the foregoing description.

What is claimed is:

1. A friction stir welding spindle assembly comprising:
a spindle housing support comprising a shoulder housing and a pin housing, the pin housing being supported by the shoulder housing for axially moving between a forward position and a retracted position;
a shoulder spindle rotatably supported by and axially fixed to the shoulder housing, said shoulder spindle defining an axially extending shoulder chamber and comprising a shoulder nose end for mounting a shoulder tool thereonto; and
a pin spindle rotatably supported by and axially fixed to the pin housing, said pin spindle comprising a pin nose end for mounting a pin head thereonto;
wherein the shoulder spindle and the pin spindle are rotatable independently from each other during a friction stir welding process; and
wherein the pin spindle is axially movable inside the shoulder chamber between a forward position and a retracted position.

2. The spindle assembly of claim 1 further comprising one or more servo motors for driving the pin housing axially between a forward position and a retracted position.

3. The spindle assembly of claim 1 further comprising a shoulder adapter for mounting a shoulder tool onto the nose end of the shoulder spindle, said shoulder adapter comprising a splined nut and an ejection ring to assist in mounting a shoulder tool onto the shoulder spindle.

4. The spindle assembly of claim 1 further comprising a pin adapter for mounting a pin head onto the pin spindle, wherein said pin head comprises a pin tool axially movable in relation to the pin spindle between an operation position and a non-operation position.

5. The spindle assembly of claim 4, wherein the pin tool is electromechanically driven between an operation position and a non-operation position.

6. A tool adapter assembly for mounting a welding tool onto a FSW spindle assembly, comprising:
a sleeve-like body portion having two end portions;
a socket being formed at one of the two end portions for receiving a welding tool; and
one or more sensors formed on the body portion;
wherein said one or more sensors detect an operation condition of the FSW spindle assembly during a FSW process.

7. The tool adapter assembly of claim 6, wherein said sensors comprise one or more strain gauge bridges for measuring one or more of radial and axial forces and a torque exerted on the tool adapter assembly, said strain gauge bridges being provided on the body portion between the two end portions.

8. The tool adapter assembly of claim 6, wherein said sensors comprise one or more temperature sensors mounted on the body portion.

9. The tool adapter assembly of claim 6 further comprising a weakened section formed on the body portion between the two end portions.

10. The tool adapter assembly of claim 6 further comprising a coolant conduit section in fluid communication with a main coolant conduit formed in the FSW spindle assembly.

11. A friction stir welding spindle assembly comprising:
a spindle housing support;
a shoulder spindle rotatably supported by and axially fixed to the housing support, said shoulder spindle defining an axially extending shoulder chamber;
a shoulder adapter have a predetermined mounting surface for mounting a shoulder tool onto a nose end of the shoulder spindle;
a pin spindle rotatably supported by the housing support and axially movable inside the shoulder chamber between a forward position and a retracted position; and
a pin adapter have a predetermined mounting surface for mounting a pin head onto a nose end of the pin spindle.

12. The spindle assembly of claim 11 further comprising one or more strain gauges for measuring a radial or axial force or a torque exerted on at least one of the shoulder and pin adapters.

13. The spindle assembly of claim 12 further comprising one or more slip ring assemblies for transmitting signals detected by the stain gauges to a data processing device.

14. The spindle assembly of claim 11 further comprising one or more temperature sensors for measuring a temperature of at least one of the shoulder and pin adapters.

15. The spindle assembly of claim 11 further comprising:
a plurality of bearings rotatably supporting the shoulder and pin spindles; and
one or more temperature sensors for measuring a temperature of at least one of the plurality of bearings.

16. The spindle assembly of claim 11 further comprising:
a shoulder tool mounted onto the shoulder adapter and defining a tool chamber communicating with the shoulder chamber; and
a pin head comprising a pin tool;
wherein the pin tool extends outwardly from the shoulder and tool chambers when the spindle assembly is in an operating position and retracts inside the shoulder and tool chambers when the spindle assembly is in a non-operation position.

17. The spindle assembly of claim 11 further comprising one or more encoders for monitoring the rotary and axial relative positions of the shoulder spindle and the pin spindle.

18. A friction stir welding system, comprising a friction stir welding spindle assembly according to claim 11 and a control device, said control device comprising:
a pin position control unit for determining a penetration position of the pin head relative the shoulder spindle;
a feeding speed control unit for determining a feeding speed of the spindle assembly; and
a rotary encoder for determining an angular position of at least one of the shoulder and pin spindles;
wherein the control device controls a friction stir welding process based on one or more welding parameters detected during a welding processing.

19. The welding system of claim 18, wherein said one or more welding parameters comprise one or more of the following:
a rotation speed of each of the shoulder and pin spindles;
one or more of radial and axial forces and torque exerted on the shoulder and pin adapters during a friction stir welding process;
a temperature detected at one or more of the shoulder adapter, the pin adapter, and a plurality of bearings used to rotatably support the shoulder and pin spindles;
a pin position relative to the shoulder spindle in an axial direction;
an angular position of at least one of the shoulder and pin spindles; and
a feeding speed of the spindle assembly.

20. The welding system of claim 18 further comprising a cooling system for adjusting an temperature of the spindle assembly during a friction stir welding process, said cooling system comprising a coolant conduit formed in the shoulder adapter.
